(19) United States
(12) Patent Application Publication
(10) Pub. No.: US 2019/0353505 A1
(43) Pub. Date: Nov. 21, 2019

(54) POSITION MEASUREMENT APPARATUS

(71) Applicant: Mitutoyo Corporation, Kawasaki (JP)

(72) Inventors: Masashi Tsuboi, Kanagawa (JP); Yuichi Ichikawa, Kanagawa (JP)

(21) Appl. No.: 16/414,333

(22) Filed: May 16, 2019

(30) Foreign Application Priority Data
May 21, 2018 (JP) 2018-097112

(51) Int. Cl. G01D 5/347

(52) U.S. Cl. CPC G01D 5/34776; G01D 5/34715

(57) ABSTRACT

A relative position identifying unit identifies a relative position of a scale to a light receiving unit. An absolute position identifying unit identifies an absolute position of the scale at a timing of execution of a synchronization instruction. A determining unit determines a measurement reference position based on the absolute position at the timing and the relative position at the timing. A current position calculator calculates a current position of the scale based on the measurement reference position and the relative position identified by the relative position identifying unit. A control unit as a synchronization instructing unit executes the synchronization instruction on the absolute position identifying unit and the determining unit.

### CROSS-REFERENCE TO RELATED APPLICATIONS

The present application claims priority to a Japanese Patent Application number 2018-097112, filed on May 21, 2018. The contents of this application are incorporated herein by reference in their entirety.

### BACKGROUND ART

### Technical Field

The present invention relates to a position measurement apparatus to measure a position of an object to be measured.

Conventionally, there has been known a position measurement apparatus that includes a photoelectric encoder. The position measurement apparatus irradiates a scale mounted to a stage movable in one axis direction with a light, detects an amount of change of the light passing through the scale in association with a movement of the scale by a light receiving unit, and measures a position of an object to be measured based on an electrical signal output from the light receiving unit (for example, see Japanese Unexamined Patent Application Publication No. 2017-116302).

There have been known an encoder with an incremental method and an encoder with an absolute method as the photoelectric encoder. The encoder with the incremental method successively detects a relative position of a scale with respect to an origin determined in an initial setting to measure a position. The encoder with the absolute method measures an absolute position on a scale to measure a position.

The encoder with the incremental method is advantageous in a high measurement speed. However, there is a problem that a measurement error caused by powering-off a measuring instrument and an excessive speed requires resetting the origin. Although the encoder with the absolute method is advantageous in that the setting of the origin is unnecessary, a low measurement speed is a problem.

### SUMMARY

Therefore, the present invention has been made in consideration of these points, and an object of the present invention is to provide a position measurement apparatus that ensures measuring a position at a high speed without a work related to a reset of an origin.

A position measurement apparatus according to an aspect of the present invention includes a relative position identifying unit, an absolute position identifying unit, a determining unit, a current position calculator, an output control unit, and a synchronization instructing unit. The relative position identifying unit identifies a relative position of a scale to a light receiving unit. The scale causes a light emitted from a light emitting unit to pass through and is movable with respect to the light emitting unit. The light receiving unit receives the light that has passed through the scale. The absolute position identifying unit identifies an absolute position of the scale at a timing of execution of a synchronization instruction. The determining unit determines a measurement reference position based on the absolute position at the timing and the relative position at the timing. The current position calculator calculates a current position of the scale based on the measurement reference position and the relative position identified by the relative position identifying unit. The output control unit outputs the current position calculated by the current position calculator. The synchronization instructing unit executes the synchronization instruction on the absolute position identifying unit and the determining unit.

### BRIEF DESCRIPTION OF DRAWINGS

FIG. 1 is a drawing illustrating an appearance of a position measurement apparatus according to this embodiment.

FIG. 2 is a drawing illustrating a configuration of the position measurement apparatus according to this embodiment.

FIG. 3 is a drawing illustrating a flow of processes at an operation start of the position measurement apparatus.

FIG. 4 is a drawing illustrating a flow of processes when an ABS offset is determined based on information stored in respective latch circuits.

FIG. 5 is a drawing illustrating a flow of processes when a current position is calculated based on the ABS offset.

### DETAILED DESCRIPTION

Hereinafter, the present invention will be described through exemplary embodiments of the present invention, but the following exemplary embodiments do not limit the invention according to the claims, and not all of the combinations of features described in the exemplary embodiments are necessarily essential to the solution means of the invention.

### [Outline of Position Measurement Apparatus 1]

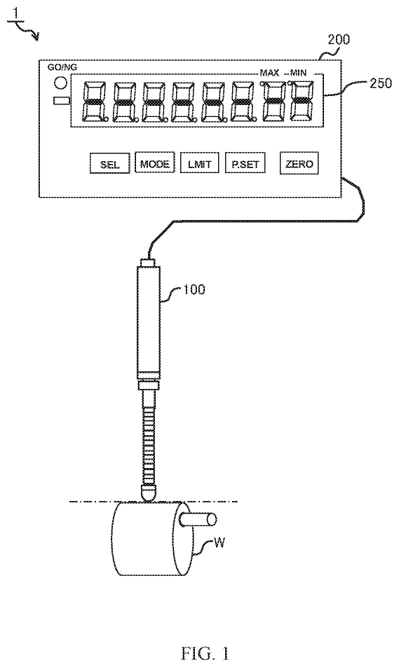

FIG. 1 is a drawing illustrating an appearance of the position measurement apparatus 1 according to this embodiment. The position measurement apparatus 1 is an apparatus that measures a position of a workpiece W in a measurement axis direction. The position measurement apparatus 1 includes a photoelectric encoder 100 and a data processing apparatus 200 that processes a measurement result by the photoelectric encoder 100. The photoelectric encoder 100 and the data processing apparatus 200 are coupled with cables including communication lines.

In this embodiment, the position measurement apparatus 1 measures height positions such as unevennesses on a surface of the workpiece W using an incremental method and an absolute method. The incremental method is a method that successively identifies a relative position of a scale with respect to an initial position (origin) set after an operation start to measure the position. The absolute method is a method that identifies an absolute position of the scale with respect to a measurement reference position predetermined before the operation start to measure the position.

At the operation start of the position measurement apparatus 1, the data processing apparatus 200 transmits a synchronous signal to the photoelectric encoder 100 using a first signal line coupling the data processing apparatus 200 and the photoelectric encoder 100. The data processing apparatus 200 causes the photoelectric encoder 100 to identify an absolute position of a scale 111 using the absolute method. The data processing apparatus 200 receives absolute position information (hereinafter referred to as ABS data) indicative of the absolute position from the photoelectric encoder 100 using the first signal line. The data processing apparatus 200 receives relative position information (hereinafter referred to as INC data) indicative of the relative position generated by the photoelectric encoder 100 using a second signal line.

The data processing apparatus 200 determines a measurement reference position based on the absolute position, which is indicated by the ABS data received from the photoelectric encoder 100, and the relative position, which is indicated by the INC data received from the photoelectric encoder 100 at a start of the identification of this absolute position. After determining the measurement reference position, the data processing apparatus 200 calculates a current position as the absolute position of the current scale based on this measurement reference position and the relative position indicated by the INC data and causes a display unit 250 to display the calculated current position. Since the identification of the relative position by the incremental method is executed faster than the identification of the absolute position by the absolute method, the position measurement apparatus 1 can calculate the current position at a high speed based on the determined measurement reference position and the identified relative position.

In identifying the relative position by the incremental method, in the case where a moving speed of the scale exceeds a speed at which the relative position is identifiable, an abnormality of failing to identify the relative position occurs. In this case, similar to at the operation start, the position measurement apparatus 1 identifies the absolute position by the absolute method and re-determines the measurement reference position based on the identified absolute position and the relative position identified by the incremental method at the start of the identification of this absolute position. Accordingly, even when an abnormality occurs in identifying the relative position, the position measurement apparatus 1 brings a probe of the photoelectric encoder 100 into contact with the workpiece W and ensures continuing the measurement without resetting the origin as the reference of the measurement of the relative position in the incremental method.

In the position measurement apparatus 1, the data processing apparatus 200 transmits the synchronous signal to the photoelectric encoder 100 and the photoelectric encoder 100 transmits the ABS data to the data processing apparatus 200 using the identical first signal line. This allows the position measurement apparatus 1 to automatically determine the measurement reference position without thickening the cable coupling the photoelectric encoder 100 and the data processing apparatus 200. Subsequently, the following describes a configuration of the position measurement apparatus 1.

### [Configuration of Photoelectric Encoder 100]

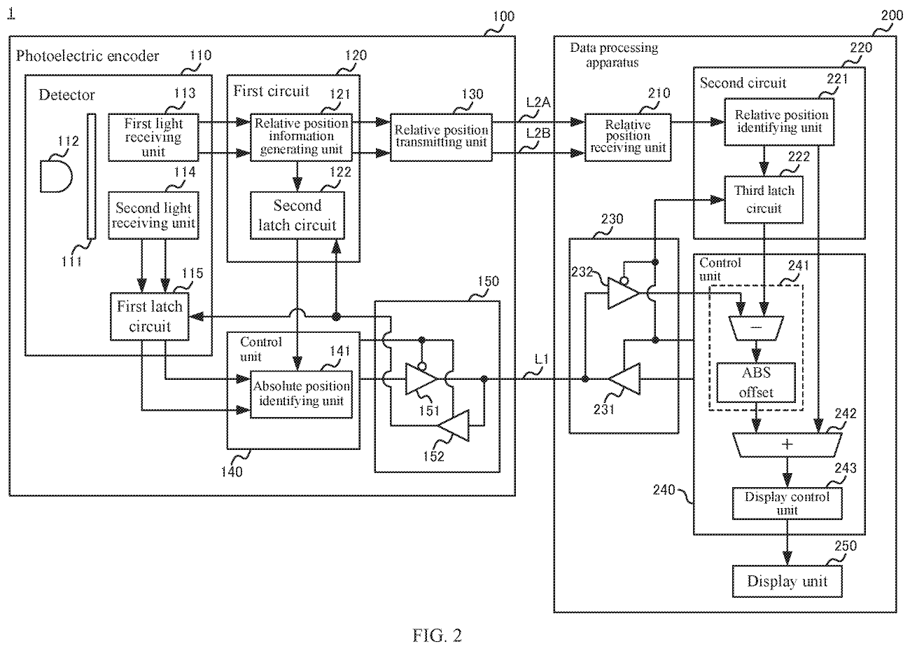

FIG. 2 is a drawing illustrating the configuration of the position measurement apparatus 1 according to this embodiment. First, the following describes a configuration of the photoelectric encoder 100 provided with the position measurement apparatus 1. As illustrated in FIG. 2, the photoelectric encoder 100 includes a detector 110, a first circuit 120, a relative position transmitting unit 130, a control unit 140, and an information transmitting/receiving unit 150.

The detector 110 includes the scale 111, a light emitting unit 112, a first light receiving unit 113, a second light receiving unit 114, and a first latch circuit 115 as a received light information latch circuit.

The scale 111 is configured to be relatively movable in the measurement axis direction with respect to the light emitting unit 112, the first light receiving unit 113, and the second light receiving unit 114. In the scale 111, an incremental pattern (hereinafter referred to as an INC pattern) corresponding to the incremental method and an absolute pattern (hereinafter referred to as an ABS pattern) corresponding to the absolute method are disposed in parallel.

The INC pattern is a pattern to measure a relative position of the scale 111. The INC pattern includes a plurality of light transmitting units that cause a light to transmit and a plurality of cutoff units that cut off the light in alternation. An interval of the INC pattern is configured shorter than an interval of the ABS pattern.

The ABS pattern is a pattern to measure a first position as a rough absolute position on the scale 111. At the plurality of respective first positions in the ABS pattern, for example, patterns corresponding to pseudorandom codes, such as M-sequence codes, are disposed as patterns that uniquely identify the plurality of respective first positions. While this embodiment provides the patterns corresponding to the pseudorandom codes as the patterns that uniquely identify the plurality of respective first positions, the configuration is not limited to this. As long as the patterns uniquely identify the plurality of respective first positions, other patterns may be disposed. For example, instead of the patterns corresponding to the pseudorandom codes, a plurality of patterns of different intervals may be disposed.

The light emitting unit 112 irradiates the scale 111 with a light. Between the light emitting unit 112 and the scale 111, a collimator lens (not illustrated) is disposed. The light emitted from the light emitting unit 112 passes through the lens to turn into a parallel light and enters the scale 111. The light emitted from the light emitting unit 112 passes through the scale 111 to turn into an interference light and this interference light enters the first light receiving unit 113.

The first light receiving unit 113 includes an INC light receiving element array that receives the light that has been transmitted through the INC pattern. When the INC light receiving element array receives the light emitted from the light emitting unit 112 and transmitted through the INC pattern, the INC light receiving element array generates four-phase signals (an A-phase sinusoidal signal, a B-phase sinusoidal signal, an AB-phase sinusoidal signal, and a BB-phase sinusoidal signal) as sinusoidal signals having phase differences of 90 degrees. The first light receiving unit 113 outputs the generated four-phase signals to the first circuit 120.

The second light receiving unit 114 includes an ABS light receiving element array that receives the light that has been transmitted through the ABS pattern. When the ABS light receiving element array receives the light emitted from the light emitting unit 112 and transmitted through the ABS pattern, the ABS light receiving element array generates an ABS light-dark signal. The second light receiving unit 114 outputs the generated ABS light-dark signal to the first latch circuit 115.

The first latch circuit 115 is, for example, a flip-flop circuit. When the first latch circuit 115 receives a synchronous signal as a first type control signal from the data processing apparatus 200 via the information transmitting/receiving unit 150, the first latch circuit 115 stores the ABS light-dark signal output from the second light receiving unit 114 as a light receiving signal used to identify the absolute position.

The first circuit 120 includes, for example, an Application Specific Integrated Circuit (ASIC) that generates the INC data (relative position information) corresponding to the relative position of the scale 111. The first circuit 120 includes a relative position information generating unit 121 and a second latch circuit 122 as a received light information latch circuit.

The relative position information generating unit 121 includes an amplifier circuit and an interpolation circuit and generates the INC data corresponding to the relative position of the scale 111. The relative position information generating unit 121 amplifies the four-phase signals output from the first light receiving unit 113 by the amplifier circuit. The relative position information generating unit 121 corrects an offset, a phase, a gain, and the like of the A-phase sinusoidal signal and the B-phase sinusoidal signal having the phase difference of 90 degrees based on the four-phase signals. The relative position information generating unit 121 divides the A-phase sinusoidal signal and the B-phase sinusoidal signal after the correction by the interpolation circuit and converts the A-phase sinusoidal signal and the B-phase sinusoidal signal into an A-phase pulse signal and a B-phase pulse signal as the INC data.

The second latch circuit 122 is, for example, a flip-flop circuit. Specifically, when the second latch circuit 122 receives the synchronous signal from the data processing apparatus 200 via the information transmitting/receiving unit 150, the second latch circuit 122 stores the A-phase pulse signal and the B-phase pulse signal as the INC data generated by the relative position information generating unit 121.

The relative position transmitting unit 130 is, for example, coupled to the data processing apparatus 200 via second signal lines L2A and L2B corresponding to serial ports. The relative position transmitting unit 130 transmits the INC data to the data processing apparatus 200 via the second signal lines L2A and L2B.

The control unit 140 is, for example, a general-purpose microcomputer including an absolute position identifying unit 141. When the information transmitting/receiving unit 150 receives the synchronous signal from the data processing apparatus 200, the absolute position identifying unit 141 identifies the absolute position of the scale 111. Specifically, the absolute position identifying unit 141 identifies the absolute position based on the ABS light-dark signal as detected information stored in the first latch circuit 115 and the INC data stored in the second latch circuit 122.

More specifically, the absolute position identifying unit 141 acquires the ABS light-dark signal stored in the first latch circuit 115 and amplifies the acquired ABS light-dark signal and removes noise from the acquired ABS light-dark signal. The absolute position identifying unit 141 converts the amplified and noise-removed ABS light-dark signal into a digital signal.

The absolute position identifying unit 141 identifies one pseudorandom code among the plurality of pseudorandom codes disposed in the ABS pattern based on the ABS light-dark signal converted into the digital signal. The absolute position identifying unit 141 identifies the first position as the rough absolute position preliminarily associated with the identified pseudorandom code.

The absolute position identifying unit 141 identifies the relative position of the INC pattern with the first position as a reference based on the INC data stored in the second latch circuit 122. The absolute position identifying unit 141 combines the identified first position and the identified relative position and calculates the absolute position in the scale 111 to identify the absolute position. The absolute position identifying unit 141 transmits the ABS data (absolute position information) indicative of the identified absolute position to the data processing apparatus 200 via the information transmitting/receiving unit 150 and a first signal line L1.

The information transmitting/receiving unit 150, for example, is coupled to the data processing apparatus 200 via the first signal line L1 corresponding to the serial port. The information transmitting/receiving unit 150 includes a bidirectional buffer including a buffer 151 and a buffer 152 and transmits and receives various kinds of information such as control information via the first signal line L1. Specifically, in response to an input of a control signal (for example, a high level control signal) to cause the buffer 151 to become conductive from the control unit 140, the buffer 151 transmits the information output from the control unit 140 to the data processing apparatus 200 via the first signal line L1. In response to an input of a control signal (for example, a low level control signal) to cause the buffer 152 to become conductive from the control unit 140, the buffer 152 receives the information from the data processing apparatus 200 via the first signal line L1. The buffer 152 outputs the received information to the first latch circuit 115 and the second latch circuit 122.

The information transmitting/receiving unit 150 switches whether to (i) transmit the ABS data to the data processing apparatus 200 or (ii) transmit setting information indicative of a setting state of the photoelectric encoder 100 to the data processing apparatus 200 based on a type of the control information. The setting information is, for example, correction data to correct the relative position identified in a relative position identifying unit 221.

The control information is, for example, information indicated by the control signal where the signal level becomes a predetermined level for a predetermined period. The type of the control information corresponds to a mode that causes the photoelectric encoder 100 to operate. The type of the control information is, for example, indicated by a pulse width of the control signal. Doing so allows the position measurement apparatus 1 to change the mode that causes the photoelectric encoder 100 to operate using the one first signal line L1. For example, the position measurement apparatus 1 can cause the photoelectric encoder 100 to transmit the setting information and transmit the ABS data.

In response to the reception of the synchronous signal as first control information from the data processing apparatus 200, the information transmitting/receiving unit 150 transmits the ABS data to the data processing apparatus 200 via the first signal line L1. In response to a reception of an acquisition request signal requesting the acquisition of the setting information as second control information from the data processing apparatus 200, the information transmitting/receiving unit 150 transmits the setting information to the data processing apparatus 200. By switching the transmitted data according to the type of the control information by the information transmitting/receiving unit 150, the position measurement apparatus 1 can reduce an increase in the number of cables coupling the photoelectric encoder 100 and the data processing apparatus 200.

### [Configuration of Data Processing Apparatus 200]

Next, the following describes the configuration of the data processing apparatus 200. As illustrated in FIG. 2, the data processing apparatus 200 includes a relative position receiving unit 210, a second circuit 220, an apparatus transmitting/receiving unit 230, a control unit 240, and a display unit 250.

The relative position receiving unit 210 receives the A-phase pulse signal and the B-phase pulse signal as the INC data from the photoelectric encoder 100 via the second signal lines L2A and L2B. The relative position receiving unit 210 inputs the received INC data to the second circuit 220.

The second circuit 220 is, for example, the ASIC including the relative position identifying unit 221 and a third latch circuit 222 as a relative position latch circuit. The relative position identifying unit 221 identifies the relative position based on the INC data received from the photoelectric encoder 100.

First, the relative position identifying unit 221, for example, determines the position of the scale 111 at the operation start as the initial position (origin) that functions as the reference of the relative position. For example, the relative position identifying unit 221 determines the position of the scale 111 indicated by the INC data received by the relative position receiving unit 210 for the first time after the operation starts as the initial position. Subsequently, the relative position identifying unit 221 counts the number of rises and the number of falls of the A-phase pulse signal and the B-phase pulse signal from the initial position based on a phase relationship between the A-phase pulse signal and the B-phase pulse signal as the INC data newly received by the relative position receiving unit 210.

For example, the relative position identifying unit 221 sets a count value at the initial position to 0. In the case where the phase of the A-phase pulse signal leads compared with the phase of the B-phase pulse signal, the relative position identifying unit 221 adds the number of rises and the number of falls of the A-phase pulse signal and the B-phase pulse signal from the initial position to the count value. Additionally, in the case where the phase of the A-phase pulse signal delays compared with the phase of the B-phase pulse signal, the relative position identifying unit 221 subtracts the number of rises and the number of falls of the A-phase pulse signal and the B-phase pulse signal from the initial position from the count value.

Subsequently, the relative position identifying unit 221 calculates the relative position based on the count value calculated with the initial position as the reference and the moving amount of the scale 111 corresponding to one phase of the A-phase pulse signal and the B-phase pulse signal. The relative position identifying unit 221 corrects the relative position calculated based on the correction data included in the setting information received from the photoelectric encoder 100 to identify the relative position. The relative position identifying unit 221 outputs the identified relative position to the third latch circuit 222 and the control unit 240.

The relative position identifying unit 221 monitors waveforms of the A-phase pulse signal and the B-phase pulse signal and detects whether these waveforms are different from usual waveforms or not. When the relative position identifying unit 221 detects that the waveforms of the A-phase pulse signal and the B-phase pulse signal are different from the usual waveforms, the relative position identifying unit 221 detects that the INC data changes at a predetermined speed or more and therefore an abnormality occurs in the identification of the relative position. The relative position identifying unit 221 causes a storage area disposed in the second circuit 220 to store status information indicative of the abnormality in the identification of the relative position.

The third latch circuit 222 is, for example, a flip-flop circuit. When the third latch circuit 222 receives the high level control signal as a synchronous signal to cause a buffer 231, which will be described below, to become conductive from the information transmitting/receiving unit 150, the third latch circuit 222 stores the relative position identified by the relative position identifying unit 221.

The apparatus transmitting/receiving unit 230 is a bidirectional buffer including the buffer 231 and a buffer 232. The apparatus transmitting/receiving unit 230 transmits and receives various kinds of information such as the control information. Specifically, in response to an input of the high level control signal to cause the buffer 231 to become conductive from the control unit 240, the buffer 231 transmits the control information output from the control unit 240 to the photoelectric encoder 100 via the first signal line L1. In response to an input of the low level control signal to cause the buffer 232 to become conductive from the control unit 240, the buffer 232 receives the ABS data or the setting information indicative of the setting state of the photoelectric encoder 100 from the photoelectric encoder 100 via the first signal line L1. The buffer 232 outputs the received ABS data and the setting information to the control unit 240.

The control unit 240 is, for example, a general-purpose microcomputer including a determining unit 241, a current position calculator 242, and a display control unit 243.

The control unit 240 functions as a synchronization instructing unit that executes a synchronization instruction on the absolute position identifying unit 141 in the photoelectric encoder 100 and the determining unit 241 when a condition for identifying the absolute position is satisfied. Here, the condition for identifying the absolute position is, for example, the start of the operation of the position measurement apparatus 1 or the detection of the abnormality in the identification of the relative position in the relative position identifying unit 221. The control unit 240 transmits the synchronous signal indicative of the synchronization instruction via the first signal line L1.

The determining unit 241 determines the measurement reference position on the basis of an absolute position identified by the absolute position identifying unit 141 at a timing when the synchronization instruction is executed and the relative position latched by the third latch circuit 222 at this timing.

Specifically, the determining unit 241 determines the measurement reference position based on (i) the absolute position identified based on information stored in the first latch circuit 115 and the second latch circuit 122 and (ii) the relative position stored in the third latch circuit 222. For example, the determining unit 241 calculates a difference value between the identified absolute position and the relative position stored in the third latch circuit 222, and determines the ABS offset indicative of the measurement reference position to be the calculated difference value. The determining unit 241 causes a predetermined storage area disposed in the data processing apparatus 200 to store the determined ABS offset.

The current position calculator 242 calculates the current position of the scale 111 based on the ABS offset stored in the predetermined storage area and the relative position output from the relative position identifying unit 221. Specifically, the current position calculator 242 adds the relative position output from the relative position identifying unit 221 to the ABS offset stored in a storage area in the control unit 240 to calculate the current position of the scale 111.

The display control unit 243 functions as an output control unit that outputs the current position calculated by the current position calculator 242 and, for example, causes the display unit 250 to display the information indicative of the current position. The display control unit 243 also causes the display unit 250 to display information indicative of the standby state from when the control unit 240 executes the synchronization instruction until the current position calculator 242 identifies the current position. For example, the display control unit 243 changes a display state of a seven-segment display provided in the display unit 250 to display the current position to a display state displaying an underscore. This allows the position measurement apparatus 1 to cause a user to recognize the state in which the current position cannot be temporarily calculated.

### Operation Example

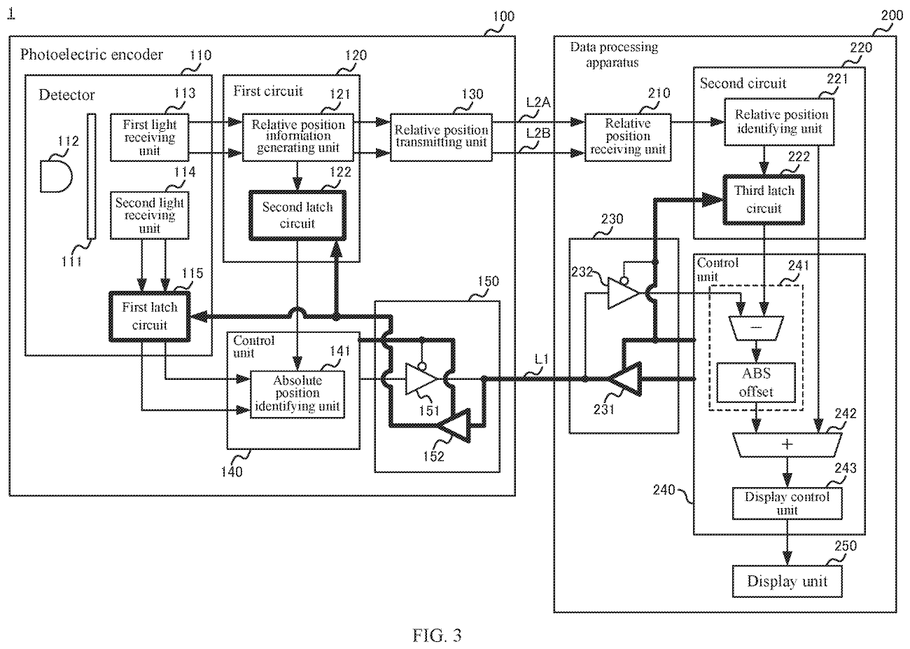

Next, the following describes the operation of the position measurement apparatus 1 with reference to FIG. 3 to FIG. 5. FIG. 3 to FIG. 5 illustrate signal lines and function blocks corresponding to flows of processes described in the respective drawings in the emphatic manner with bold lines.

FIG. 3 is a drawing illustrating the flow of processes at the operation start of the position measurement apparatus 1. The control unit 240 in the data processing apparatus 200 inputs the high level control signal to cause the buffer 231 to become conductive to the buffer 231 in the apparatus transmitting/receiving unit 230 at the operation start of the position measurement apparatus 1. The control unit 240 transmits the synchronous signal to the photoelectric encoder 100 via the buffer 231 in the apparatus transmitting/receiving unit 230 and the first signal line L1.

The control unit 140 in the photoelectric encoder 100 inputs the high level control signal to cause the buffer 152 to become conductive to the information transmitting/receiving unit 150. Accordingly, the buffer 152 in the information transmitting/receiving unit 150 can input the synchronous signal received from the data processing apparatus 200 via the first signal line L1 to the first latch circuit 115 and the second latch circuit 122.

In response to the input of the synchronous signal, the first latch circuit 115 stores the ABS light-dark signal output from the second light receiving unit 114. In response to the input of the synchronous signal, the second latch circuit 122 stores the INC data corresponding to the relative position of the scale 111.

Here, the high level control signal output from the control unit 240 is also input to the third latch circuit 222 as the synchronous signal to identify the absolute position. In response to the input of the synchronous signal, the third latch circuit 222 stores the relative position output from the relative position identifying unit 221.

The first circuit 120 and the second circuit 220 are achieved with ASICs, thereby operating at speeds faster than those of the control unit 140 and the control unit 240. In view of this, a period from when the relative position information generating unit 121 generates the INC data until the relative position identifying unit 221 identifies the relative position is extremely shorter than a period until the absolute position identifying unit 141 in the control unit 140 identifies the absolute position. Accordingly, the second latch circuit 122 and the third latch circuit 222 store the information indicative of the relative position of the scale 111 at the timing of transmitting the synchronous signal. The first latch circuit 115 stores the ABS light-dark signal corresponding to the absolute position of the scale 111 at the timing of transmitting the synchronous signal.

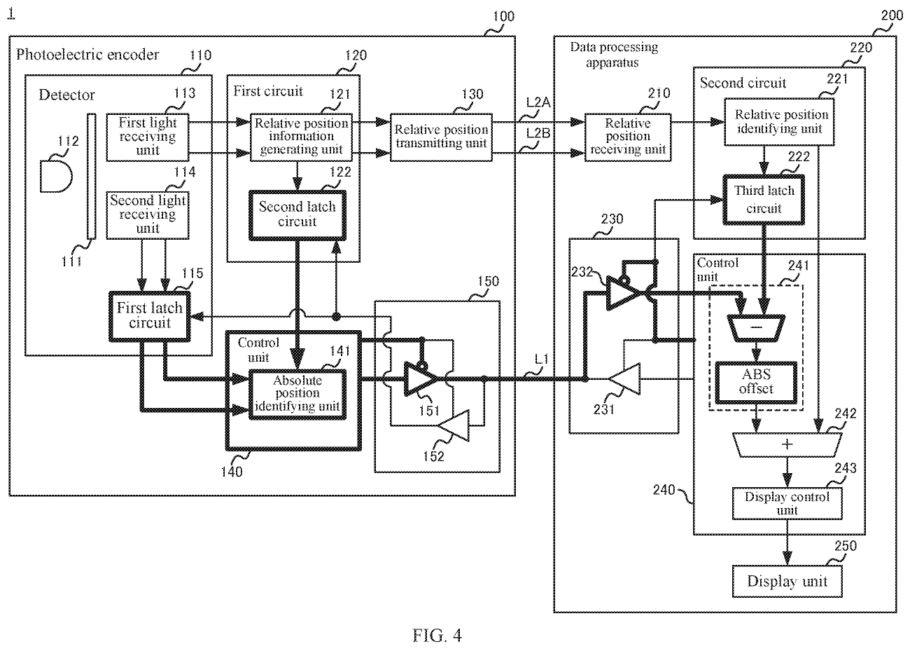

After the information is stored in the respective latch circuits, the determining unit 241 determines the ABS offset (reference measurement position). FIG. 4 is a drawing illustrating a flow of processes when the ABS offset is determined based on the information stored in the respective latch circuits.

When the transmission of the synchronous signal is completed on the data processing apparatus 200 side, the control unit 240 outputs the low level control signal to cause the buffer 232 to become conductive to the apparatus transmitting/receiving unit 230 to receive the ABS data from the photoelectric encoder 100 side. While the low level control signal is input, the buffer 232 in the apparatus transmitting/receiving unit 230 stands by the reception of the ABS data transmitted from the photoelectric encoder 100.

On the photoelectric encoder 100 side, the control unit 140 detects that the information transmitting/receiving unit 150 has received the synchronous signal based on the data transmission/reception situations in the information transmitting/receiving unit 150. Subsequently, when the control unit 140 detects the completion of the reception of the synchronous signal, the absolute position identifying unit 141 identifies the absolute position based on the ABS light-dark signal stored in the first latch circuit 115 and the INC data stored in the second latch circuit 122.

In response to the identification of the absolute position, the control unit 140 outputs the low level control signal to the information transmitting/receiving unit 150. The control unit 140 transmits the ABS data indicative of the absolute position identified by the absolute position identifying unit 141 to the data processing apparatus 200 via the buffer 151 in the information transmitting/receiving unit 150 and the first signal line L1. When the transmission of the ABS data is completed, the control unit 140 outputs the high level control signal to the information transmitting/receiving unit 150.

The control unit 240 receives the ABS data from the photoelectric encoder 100 via the apparatus transmitting/receiving unit 230. The control unit 240 acquires the relative position stored in the third latch circuit 222. The determining unit 241 subtracts the acquired relative position from the absolute position indicated by the ABS data to determine the ABS offset and causes the storage area disposed in the data processing apparatus 200 to store this ABS offset.

When the control unit 240 acquires the ABS data and the relative position, the control unit 240 inputs an ON signal to the buffer 231 in the apparatus transmitting/receiving unit 230. The control unit 240 transmits the acquisition request signal requesting the acquisition of the setting information indicative of the setting state of the photoelectric encoder 100 to the photoelectric encoder 100 via the buffer 231 in the apparatus transmitting/receiving unit 230 and the first signal line L1.

The control unit 140 detects that the information transmitting/receiving unit 150 has received the acquisition request signal based on the data transmission/reception situations in the information transmitting/receiving unit 150. Subsequently, when the control unit 140 detects the completion of the reception of the acquisition request signal, the absolute position identifying unit 141 transmits the setting information indicative of the setting state of the photoelectric encoder 100 to the data processing apparatus 200.

The control unit 140 outputs the correction data of the relative position included in the setting information received from the photoelectric encoder 100 to the relative position identifying unit 221. This allows the relative position identifying unit 221 to correct the relative position based on this correction data.

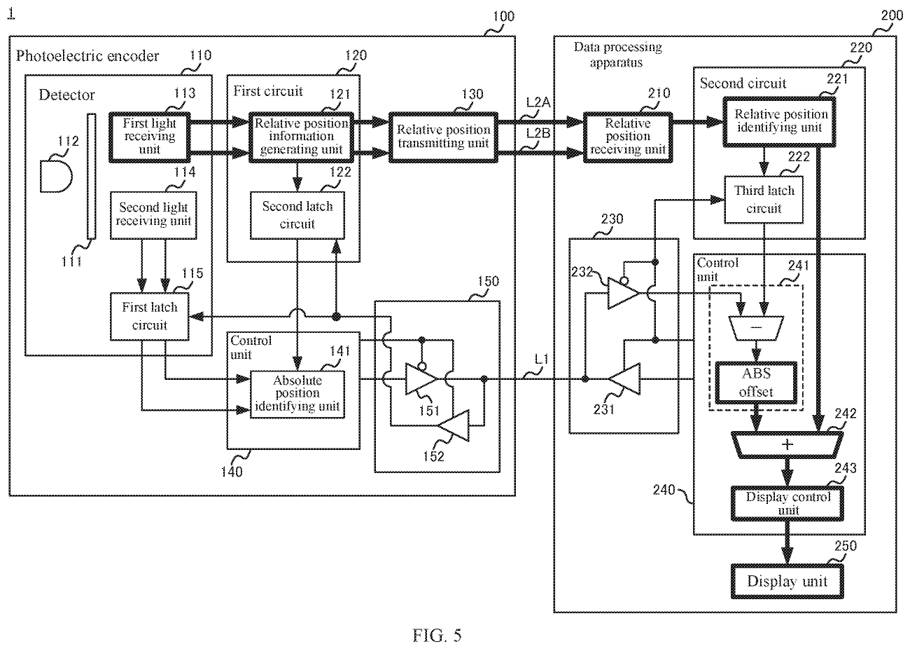

After the ABS offset is stored in the storage area disposed in the data processing apparatus 200, the current position calculator 242 calculates the current position of the scale 111 based on this ABS offset. FIG. 5 is a drawing illustrating a flow of processes when the current position is calculated based on the ABS offset.

First, the relative position information generating unit 121 generates the INC data based on the four-phase signals generated by the first light receiving unit 113. The relative position identifying unit 221 identifies the relative position based on the INC data received via the relative position transmitting unit 130, the second signal lines L2A and L2B, and the relative position receiving unit 210. The relative position identifying unit 221 corrects the identified relative position based on the correction data and outputs the relative position after the correction to the current position calculator 242.

The current position calculator 242 adds the ABS offset stored in the storage area in the control unit 240 to the relative position output from the relative position identifying unit 221 to calculate the current position of the scale 111. The display control unit 243 causes the display unit 250 to display the current position calculated by the current position calculator 242.

Afterwards, when an abnormality that the relative position identifying unit 221 cannot identify the relative position caused by, for example, the moving speed of the scale 111 in excess of a speed at which the relative position is identifiable by the relative position identifying unit 221 is detected, the control unit 240 re-transmits the synchronous signal to the photoelectric encoder 100. Afterwards, the photoelectric encoder 100 and the data processing apparatus 200 re-execute the processes illustrated from FIG. 3 to FIG. 5, and the ABS offset is re-determined. The current position calculator 242 adds the re-determined ABS offset to the relative position output from the relative position identifying unit 221 to calculate the current position of the scale 111.

From when the detection of the abnormality that the relative position identifying unit 221 cannot identify the relative position until the current position calculator 242 calculates the current position, the display control unit 243 causes the display unit 250 to display the information indicative of the standby state. In response to the calculation of the current position by the current position calculator 242, the display control unit 243 causes the display unit 250 to display this current position.

### Effects of this Embodiment

As described above, the position measurement apparatus 1 according to the embodiment determines the measurement reference position based on the absolute position of the scale 111 identified at the timing of the execution of the synchronization instruction and the relative position of the scale 111 identified at this timing. Thus, the position measurement apparatus 1 can accurately synchronize the relative position identified by the incremental method and the absolute position identified by the absolute method.

Further, in the case where the position measurement apparatus 1 detects the abnormality that the relative position cannot be identified due to, for example, the moving speed of the scale 111 in excess of the speed at which the relative position is measurable, the position measurement apparatus 1 executes the synchronization instruction on the absolute position identifying unit 141 and the determining unit 241, thus re-determining the measurement reference position. Accordingly, when the abnormality that the relative position is unidentifiable occurs, the position measurement apparatus 1 can continue the measurement without resetting the origin as the reference for the measurement of the relative position in the incremental method by bringing the probe of the photoelectric encoder 100 in contact with the workpiece W by the user.

In the position measurement apparatus 1, the data processing apparatus 200 transmits the synchronous signal to the photoelectric encoder 100 and the photoelectric encoder 100 transmits the ABS data to the data processing apparatus 200 using the identical first signal line L1. This configuration allows the position measurement apparatus 1 to automatically determine the measurement reference position without thickening the cable coupling the photoelectric encoder 100 and the data processing apparatus 200.

While the present invention has been described above using the embodiments, the technical scope of the present invention is not limited to the scope described in the above-described embodiments, and various modifications and changes are possible within the scope of the gist. For example, in a specific embodiment of the distribution and integration of the apparatus, the present invention is not limited to the above-described embodiments and can be functionally or physically distributed and integrated in any unit for all or a part thereof. Additionally, a new embodiment created by any combination of the plurality of embodiments is also included in the embodiment of the present invention. Effects of the new embodiment created by the combination also include the effects of the original embodiments.

For example, while the above-described embodiment describes the case of coupling the photoelectric encoder 100 and the data processing apparatus 200 with the cable as the example, the photoelectric encoder 100 and the data processing apparatus 200 may be housed in an integrated housing. Moreover, while the above-described description gives the example where the data processing apparatus 200 includes the display unit 250 and the display control unit 243 causes the display unit 250 to display the information indicative of the current position, the data processing apparatus 200 needs not to include the display unit 250 and a display unit provided with another apparatus may display the information indicative of the current position. For example, the display control unit 243 in the data processing apparatus 200 may output the information indicative of the current position to a display apparatus including a display unit and may cause this display unit to display the information indicative of the current position.

What is claimed is:

1. A position measurement apparatus comprising:
a relative position identifying unit that identifies a relative position of a scale to a light receiving unit, the scale causing a light emitted from a light emitting unit to pass through and being movable with respect to the light emitting unit, the light receiving unit receiving the light that has passed through the scale;
an absolute position identifying unit that identifies an absolute position of the scale at a timing of execution of a synchronization instruction;
a determining unit that determines a measurement reference position based on the absolute position at the timing and the relative position at the timing;
a current position calculator that calculates a current position of the scale based on the measurement reference position and the relative position identified by the relative position identifying unit;
an output control unit that outputs the current position calculated by the current position calculator; and
a synchronization instructing unit that executes the synchronization instruction on the absolute position identifying unit and the determining unit.

2. The position measurement apparatus according to claim 1, comprising:
a received light information latch circuit that stores received light information indicated by the light received by the light receiving unit at the timing; and
a relative position latch circuit that stores relative position information indicative of the relative position identified by the relative position identifying unit at the timing, wherein
the absolute position identifying unit identifies the absolute position based on the received light information stored in the received light information latch circuit, and
the determining unit determines the measurement reference position on the basis of (i) the absolute position identified based on the received light information stored in the received light information latch circuit and (ii) the relative position indicated by the relative position information stored in the relative position latch circuit.

3. The position measurement apparatus according to claim 1, wherein
the determining unit determines a difference value between the absolute position at the timing and the relative position at the timing and determines an offset value indicative of the measurement reference position to be the calculated difference value, and
the current position calculator adds the identified relative position to the offset value to calculate the current position.

4. The position measurement apparatus according to claim 1, wherein
the synchronization instructing unit executes the synchronization institution on the absolute position identifying unit and the determining unit when a condition for identifying the absolute position is satisfied.

5. The position measurement apparatus according to claim 4, wherein
when an abnormality is detected in the identification of the relative position by the relative position identifying unit, the synchronization instructing unit executes the synchronization instruction on the absolute position identifying unit and the determining unit.

6. The position measurement apparatus according to claim 1, wherein
the output control unit causes a display unit to display information indicative of a standby state from when the synchronization instructing unit executes the synchronization instruction until the current position calculator identifies the current position.

7. The position measurement apparatus according to claim 1, wherein
the synchronization instructing unit transmits a synchronous signal indicative of the synchronization instruction via a signal line that receives the absolute position identified by the absolute position identifying unit.

8. The position measurement apparatus according to claim 7, wherein
an incremental pattern and absolute pattern are disposed in parallel in the scale,
the position measurement apparatus further includes
a first latch circuit that stores a first light-dark signal having transmitted through the absolute pattern and output from the light receiving unit at a timing when the synchronous signal is transmitted,
a second latch circuit that stores a second light-dark signal having transmitted through the incremental pattern and output from the light receiving unit at the timing when the synchronous signal is transmitted, and
a third latch circuit that stores a third light-dark signal at the timing when the synchronous signal is transmitted, the third light-dark signal being the second light-dark signal having transmitted through the incremental pattern and output from the light receiving unit transmitted via a transmission path,
the absolute position identifying unit identifies the absolute position on the basis of (i) the first light-dark signal stored in the first latch circuit and (ii) the second light-dark signal stored in the second latch circuit, and
the relative position identifying unit identifies the relative position on the basis of the third light-dark signal stored in the third latch circuit.

9. The position measurement apparatus according to claim 1, wherein
the output control unit causes the display unit to display information indicative of the current position of the scale calculated by the current position calculator.
